(19) United States
(12) Patent Application Publication
(10) Pub. No.: US 2013/0002775 A1
(43) Pub. Date: Jan. 3, 2013

(54) IMAGE FORMING APPARATUS INCLUDING RECORDING HEAD FOR EJECTING LIQUID DROPLETS

(75) Inventor: Mitsuya MATSUBARA, Kanagawa (JP)

(73) Assignee: RICOH COMPANY, LTD., Tokyo (JP)

(21) Appl. No.: 13/526,631

(22) Filed: Jun. 19, 2012

(30) Foreign Application Priority Data
Jun. 28, 2011 (JP) 2011-143543

(51) Int. Cl. B41J 2/19

(52) U.S. Cl. 347/92

(57) ABSTRACT

An image forming apparatus includes a recording head disposed to eject droplets of liquid upward to form an image on a lower face of a recording medium conveyed to a position above the recording head. The recording head includes nozzles, individual liquid chambers, a common liquid chamber, a liquid supply port, a bubble discharge channel, and a valve unit. The nozzles eject droplets of the liquid. The individual liquid chambers are communicated with the nozzles. The common liquid chamber is communicated with the individual liquid chambers. The liquid supply port supplies the liquid to the common liquid chamber. The bubble discharge channel is communicated with the common liquid chamber to communicate the common liquid chamber with an outside of the recording head. The valve unit is disposed at the bubble discharge channel to open and close the bubble discharge channel.

### CROSS-REFERENCE TO RELATED APPLICATION

This patent application is based on and claims priority pursuant to 35 U.S.C. §119 to Japanese Patent Application No. 2011-143543, filed on Jun. 28, 2011, in the Japan Patent Office, the entire disclosure of which is hereby incorporated by reference herein.

### BACKGROUND

1. Technical Field

This disclosure relates to an image forming apparatus, and more specifically to an image forming apparatus including a recording head for ejecting liquid droplets upward.

2. Description of the Related Art

Image forming apparatuses are used as printers, facsimile machines, copiers, plotters, or multi-functional devices having two or more of the foregoing capabilities. As one type of image forming apparatus employing a liquid-ejection recording method, an inkjet recording apparatus is known that uses a recording head (liquid ejection head or liquid-droplet ejection head) for ejecting droplets of ink or other liquid.

As a conventional type of image forming apparatus, for example, JP 2001-341421-A proposes an image forming apparatus having a recording head to eject ink droplets upward from nozzles to form images on a lower face of a recording medium.

In such a configuration, bubbles having flown into an internal channel of the liquid ejection head may cause defective ejection, such as deviated ejection or ejection error, thus hampering stable droplet ejection and degrading image quality.

In particular, as described above, in a case where the liquid ejection head is disposed so as to eject liquid droplets vertically upward, bubbles may flow into a common liquid chamber for supplying ink to individual liquid chambers communicated with the nozzles and further move into the individual liquid chambers by flotation. Such bubbles may block a channel downstream from the common liquid chamber, thus hampering droplet ejection.

### BRIEF SUMMARY

In an aspect of this disclosure, there is provided an image forming apparatus including a recording head disposed to eject droplets of liquid upward to form an image on a lower face of a recording medium conveyed to a position above the recording head. The recording head includes a plurality of nozzles, a plurality of individual liquid chambers, a common liquid chamber, a liquid supply port, a bubble discharge channel, and a valve unit. The plurality of nozzles ejects droplets of the liquid. The plurality of individual liquid chambers is communicated with the plurality of nozzles. The common liquid chamber is communicated with the plurality of individual liquid chambers. The liquid supply port supplies the liquid to the common liquid chamber. The bubble discharge channel is communicated with the common liquid chamber to communicate the common liquid chamber with an outside of the recording head. The valve unit is disposed at the bubble discharge channel to open and close the bubble discharge channel.

### BRIEF DESCRIPTION OF THE DRAWINGS

The aforementioned and other aspects, features, and advantages of the present disclosure would be better understood by reference to the following detailed description when considered in connection with the accompanying drawings, wherein:

FIG. 1 is a schematic side view of an image forming apparatus according to an exemplary embodiment of the present disclosure;

FIG. 2 is a partial bottom view of the image forming apparatus of FIG. 1 seen from its bottom side;

FIG. 3 is a schematic block diagram of a controller of the image forming apparatus;

FIG. 4 is an external perspective view of a liquid ejection head serving as a recording head according to a first exemplary embodiment of this disclosure;

FIG. 5 is a schematic partial cross-sectional view of the liquid ejection head cut along an X plane illustrated in FIG. 4;

FIG. 6 is a schematic cross-sectional view of the liquid ejection head cut along a Y plane illustrated in FIG. 4;

FIG. 7 is a flowchart showing a procedure of bubble discharging operation in the first exemplary embodiment;

FIGS. 8A to 8I are schematic partial views of the liquid ejection head performing the procedure of bubble discharging operation of FIG. 7;

FIG. 9 is a schematic partial cross-sectional view of a liquid ejection head according to a second exemplary embodiment of the present disclosure;

FIG. 10 is a flowchart showing a procedure of bubble discharging operation in the second exemplary embodiment;

FIGS. 11A to 11G are schematic partial views of the liquid ejection head performing the procedure of bubble discharging operation of FIG. 10;

FIG. 12 is a flowchart showing another procedure of bubble discharging operation in the second exemplary embodiment;

FIGS. 13A to 13G are schematic partial views of the liquid ejection head performing the procedure of bubble discharging operation of FIG. 12;

FIGS. 14A to 14G are schematic partial views of the liquid ejection head in the second exemplary embodiment;

FIG. 15 is a schematic partial cross-sectional view of a liquid ejection head according to a third exemplary embodiment of the present disclosure;

FIG. 16 is a schematic partial cross-sectional view of a liquid ejection head according to a fourth exemplary embodiment of the present disclosure;

FIG. 17 is a schematic partial cross-sectional view of a liquid ejection head according to a fifth exemplary embodiment of the present disclosure;

FIG. 18 is a schematic partial cross-sectional view of a liquid ejection head according to a sixth exemplary embodiment of the present disclosure;

FIG. 19 is a schematic partial cross-sectional view of a liquid ejection head according to a seventh exemplary embodiment of the present disclosure; and

FIG. 20 is a schematic partial cross-sectional view of a liquid ejection head according to an eighth exemplary embodiment of the present disclosure.

The accompanying drawings are intended to depict exemplary embodiments of the present disclosure and should not be interpreted to limit the scope thereof. The accompanying drawings are not to be considered as drawn to scale unless explicitly noted.

### DETAILED DESCRIPTION OF EXEMPLARY EMBODIMENTS

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

Although the exemplary embodiments are described with technical limitations with reference to the attached drawings, such description is not intended to limit the scope of the invention and all of the components or elements described in the exemplary embodiments of this disclosure are not necessarily indispensable to the present invention.

In this disclosure, the term “sheet” used herein is not limited to a sheet of paper but be, e.g., an OHP (overhead projector) sheet, a cloth sheet, a grass sheet, a substrate, or anything on which droplets of ink or other liquid can be adhered. In other words, the term “sheet” is used as a generic term including a recording medium, a recorded medium, a recording sheet, or a recording sheet of paper. The term “image forming apparatus” refers to an apparatus that ejects ink or any other liquid onto a medium to form images on the medium. The medium is made of, for example, paper, string, fiber, cloth, leather, metal, plastic, glass, timber, and ceramic. The term “image formation”, which is used herein as a synonym for “recording” or “printing”, includes providing not only meaningful images, such as characters and figures, but meaningless images, such as patterns, to the medium (in other words, the term “image formation” includes only causing liquid droplets to land on the medium).

The term “ink” as used herein is not limited to “ink” in a narrow sense unless specifically distinguished and includes any types of liquid useable for image formation, such as recording liquid, fixing solution, DNA sample, resist, pattern material, and resin.

The term “image” used herein is not limited to a two-dimensional image and includes, for example, an image applied to a three dimensional object and a three dimensional object itself formed as a three-dimensionally molded image.

The term “image forming apparatus” includes both serial-type image forming apparatus and line-type image forming apparatus unless specified.

Referring now to the drawings, wherein like reference numerals designate identical or corresponding parts throughout the several views, exemplary embodiments of the present disclosure are described below.

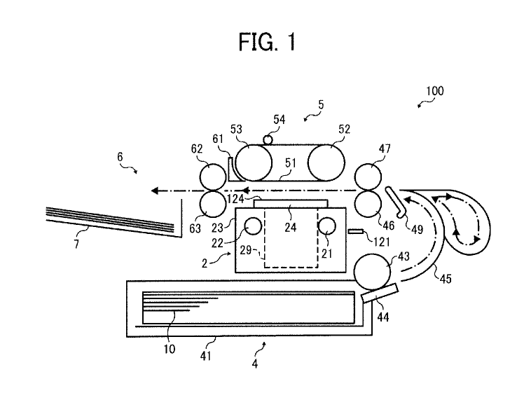

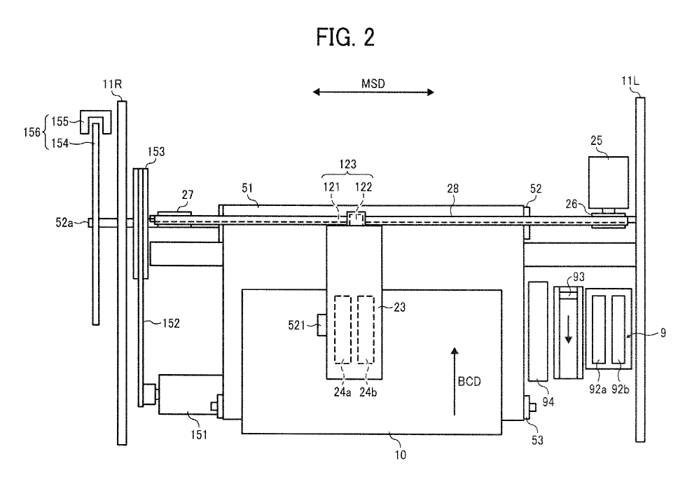

First, an image forming apparatus according to an exemplary embodiment of this disclosure is described with reference to FIGS. 1 and 2.

FIG. 1 is a partial side view of the image forming apparatus. FIG. 2 is a partial bottom view of the image forming apparatus of FIG. 1 seen from its bottom side.

In FIGS. 1 and 2, the image forming apparatus 100 is a serial-type image forming apparatus and has, e.g., an image forming device 2 and a conveyance device 5 within an apparatus body. Sheets 10 serving as recording media are fed sheet by sheet from a sheet feed device 4 disposed at a lower side of the apparatus body. While a sheet 10 is intermittently conveyed in a horizontal direction, the image forming device 2 ejects liquid droplets vertically upward to record a desired image on the sheet 10. Then, the sheet 10 is output to a sheet output tray 7 of a sheet output device 6.

As illustrated in FIG. 2, for the image forming device 2, a carriage 23 mounting recording heads 24a and 24b (collectively referred to as “recording heads 24” unless distinguished) is slidably supported by a main guide member 21 and a sub guide member 22 extending between a left side plate 11L and a right side plate 11R. The carriage 23 is moved for scanning in a main scanning direction (indicated by an arrow MSD in FIG. 2) by a main scanning motor 25 via a timing belt 28 extending between a driving pulley 26 and a driven pulley 27.

The carriage 23 mounts the recording heads 24a and 24b serving as liquid ejection heads for ejecting droplets of different color inks, e.g., yellow (Y), cyan (C), magenta (M), and black (K). The recording heads 24a and 24b are mounted on the carriage 23 so that multiple nozzles are arranged in rows in a direction (sub-scanning direction) perpendicular to the main scanning direction and ink droplets are ejected vertically upward from the nozzles.

As pressure generators for generating pressure to eject liquid droplets, the liquid ejection heads may employ, for example, piezoelectric actuators such as piezoelectric elements, thermal actuators that generate film boiling of liquid (ink) using electro/thermal converting elements such as heat-generation resistant to cause phase change, shape-memory-alloy actuators that change metal phase by a temperature change, or electrostatic actuators that generate pressure by electrostatic force. The carriage 23 may mount a liquid ejection head to eject fixing solution that reacts ink to enhance the fixing performance of ink.

The carriage 23 mounts head tanks 29 to supply different color inks to the respective nozzle rows. To the head tanks 29, different color inks are supplied from ink cartridges (main tanks) removably mounted to the apparatus body. In this exemplary embodiment, since the recording heads 24 eject liquid droplets vertically upward, it is not necessarily required to create a negative pressure in the recording heads 24 to prevent dropping of liquid from the recording heads 24. Hence, in this exemplary embodiment, the head tanks 29 are simply buffer tanks.

An encoder scale 121 with a given pattern extends along the main scanning direction MSD of the carriage 23 between the side plates 11L and 11R. On the carriage 23 is mounted a first encoder sensor 122 serving as a transmissive photosensor to read a scale (scale index serving as position identifier) of the encoder scale 121. The encoder scale 121 and the first encoder sensor 122 form a linear encoder (main scanning encoder) 123 to detect movement of the carriage 23.

As illustrated in FIG. 2, a maintenance device 9 (maintenance-and-recovery device) is disposed in a non-printing area (non-recording area) at one end in the main scanning direction of the carriage 23. The maintenance device 9 maintains and recovers nozzle conditions of the recording heads 24. The maintenance device 9 includes caps 92a and 92b, a wiping member (wiper blade) 93, and a droplet receptacle 94. The caps 92a and 92b (hereinafter collectively referred to as “caps 92” unless distinguished) cap (covers) respective nozzle faces of the recording heads 24. The wiping member 93 wipes the nozzle faces of the recording heads 23. The droplet receptacle 94 stores liquid droplets ejected by maintenance ejection (flushing) in which liquid droplets not contributing to a resultant image are ejected for, e.g., removing viscosity-increased liquid.

The sheet feed device 4 has a sheet feed tray 41, a sheet feed roller 43, a separation pad 44, a conveyance guide member 45, and registration rollers 46 and 47. The sheets 10 stacked on the sheet feed tray 41 are fed sheet by sheet by the sheet feed roller 43 of e.g., a half-moon shape and the separation pad 44, and sent along the conveyance guide member 45 to a nipping portion between the registration rollers 46 and 47 disposed upstream from the conveyance device 5. Then, the sheet 10 is attached on and conveyed by a conveyance belt 51 of the conveyance device 5. A sheet sensor 49 to detect the sheet 10 is disposed upstream from the registration rollers 46 and 47 in a direction in which the sheet 10 is transported in the image forming apparatus 100.

The conveyance device 5 includes, e.g., the conveyance belt 51, a conveyance roller 52, a driven roller 53, a charging roller 54, and a platen member. The conveyance belt 51 of an endless shape is looped around the conveyance roller 52 and the driven roller 53. The charging roller 54 charges the conveyance belt 51. The platen member is disposed at a position opposing the image forming device 2 to maintain the flatness of the conveyance belt 51.

As the conveyance roller 51 is rotated by a sub-scanning motor 151 via a timing belt 152 and a timing pulley 153, the conveyance belt 51 circulates in a belt conveyance direction (also referred to as sub-scanning direction or sheet conveyance direction) indicated by an arrow BCD illustrated in FIG. 2.

The image forming apparatus 100 further includes a rotary encoder (sub scanning encoder) 156 to detect the moving distance and position of the conveyance belt 51. The rotary encoder 156 includes a code wheel 154 and a second encoder sensor 155. The code wheel 154 with a predetermined pattern is mounted on a shaft 52a of the conveyance roller 52. The second encoder sensor 155 is e.g., a transmissive photosensor to detect the pattern of the code wheel 154.

The sheet output device 6 has a separation member 61, a sheet output roller 62, and a spur 63. The sheet 10 with an image recorded thereon is separated from the conveyance belt 51 by the separation member 61 and discharged from between the sheet output roller 62 and the spur 63 to the sheet output tray 7.

In the image forming apparatus 100 having the above-described configuration, the sheet 10 is separated and fed sheet by sheet from the sheet feed tray 41 of the sheet feed device 4 and attached on the conveyance belt 51 by static electricity. Then, with circulation of the conveyance belt 51, the sheet 10 is conveyed in a horizontal direction. By driving the recording heads 24 according to image signals while moving the carriage 23, ink droplets are ejected from below to above toward the sheet 10 stopped above the recording heads 24 to form one line of a desired image. Then, the sheet 10 is fed by a certain distance to prepare for recording another line of the image. After the image recording is completed, the sheet 10 is discharged to the sheet output tray 7.

In performing maintenance and recovery operation of the nozzles of the recording heads 24, the carriage 23 is moved to a home position opposing the maintenance device 9, and maintenance and recovery operation, such as nozzle suction and maintenance ejection (flushing), are performed. For nozzle suction, with the nozzles sealed with the cap 92a, ink is sucked from the nozzles and discharged to, e.g., a waste tank. For maintenance ejection, as described above, liquid droplets not contributing to a resultant image are ejected from the nozzles for, e.g., preventing clogging of the nozzles. Such maintenance and recovery operation allows stable droplet ejection in image formation.

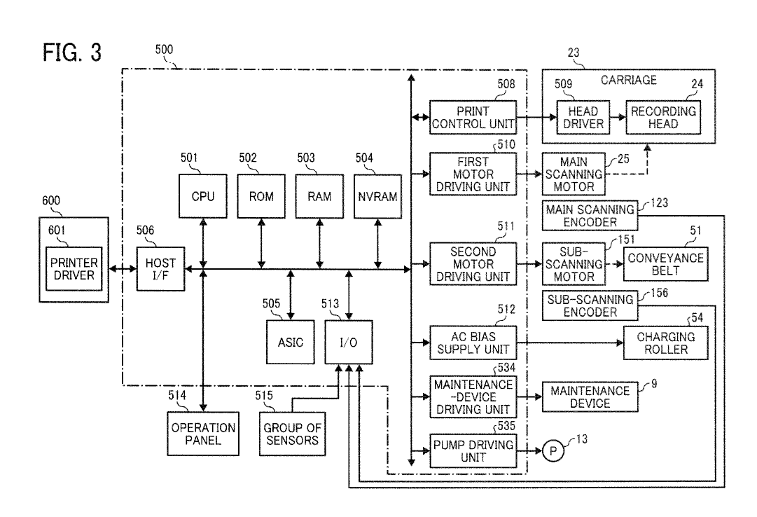

Next, a controller of the image forming apparatus 100 is described with reference to FIG. 3.

In FIG. 3, a controller 500 includes a central processing unit (CPU) 501, a read-only memory (ROM) 502, a random access memory (RAM) 503, a rewritable non-volatile memory 504, and an application specific integrated circuit (ASIC) 505. The CPU 501 controls the entire image forming apparatus. The ROM 502 stores programs, including programs causing the CPU 501 to perform control processing according to exemplary embodiments described below, and other fixed date. The RAM 503 temporarily stores image data or other data. The rewritable non-volatile memory 504 retains data even while the apparatus is powered off. The ASIC 505 processes signals for image data, performs sorting or other image processing, or processes input and output signals for controlling the entire image forming apparatus.

The controller 500 also has a print control unit 508, a head driver (driver integrated circuit) 509, a first motor driving unit 510, a second motor driving unit 511, and an alternating current (AC) bias supply unit 512. The print control unit 508 includes a data transmitter and a driving signal generator to drive and control the recording heads 24 according to print data. The head driver 509 drives the recording heads 24 mounted on the carriage 23. The first motor driving unit 510 and the second motor driving unit 511 drive the main scanning motor 25 to move the carriage 23. The sub-scanning motor 151 circulates the conveyance belt 51. The AC bias supply unit 512 supplies AC bias to the charging roller 54.

The controller 500 is connected to an operation panel 514 for inputting and displaying information necessary to the image forming apparatus.

The controller 500 further includes an interface (I/F) 506 to transmit and receive data and signals to and from a host 600, such as an information processing device (e.g., personal computer), image reading device (e.g., image scanner), or image capturing device (e.g., digital camera), via a cable or network.

The CPU 501 of the controller 500 reads and analyzes print data stored in a reception buffer of the I/F 506, performs desired image processing, data sorting, or other processing with the ASIC 505, and transmits image data to the head driver 509. It is to be noted that dot-pattern data for image output may be created by a printer driver 601 of the host 600.

The print control unit 508 transfers the above-described image data as serial data and outputs to the head driver 509, for example, transfer clock signals, latch signals, and control signals required for the transfer of image data and determination of the transfer. In addition, the print control unit 508 has the driving signal generator including, e.g., a digital/analog (D/A) converter (to perform digital/analog conversion on pattern data of driving pulses stored on the ROM 502), a voltage amplifier, and a current amplifier, and outputs a driving signal containing one or more driving pulses to the head driver 509.

In accordance with serially-inputted image data corresponding to one image line recorded by the recording heads 24, the head driver 509 selects driving pulses forming driving signals transmitted from the print control unit 508 and applies the selected driving pulses to driving elements (e.g., piezoelectric elements) to drive the recording heads 24. At this time, the driving elements serve as pressure generators to generate energy for ejecting liquid droplets from the recording heads 24. At this time, by selecting driving pulses constituting driving signals, liquid droplets of different liquid amounts, such as large-size droplets, medium-size droplets, and small-size droplets, can be selectively ejected to form different sizes of dots.

An input/output (I/O) unit 513 acquires information from the main-scanning encoder 123, the sub scanning encoder 156, and a group of sensors 515 mounted in the image forming apparatus, extracts information necessary for controlling printing operation, and controls the print control unit 508, the first motor driving unit 510, the second motor driving unit 511, and the AC bias supply unit 512 based on the extracted information. The group of sensors 515 includes, for example, an optical sensor (sheet sensor) 521 disposed at the carriage 23 to detect the position of the sheet of recording media, a thermistor to monitor temperature and/or humidity in the apparatus, a voltage sensor to monitor the voltage of a charging belt, and an interlock switch to detect the opening and closing of a cover. The I/O unit 513 is capable of processing information from such various types of sensors.

For example, the CPU 501 determines a driving output value (control value) for the main scanning motor 25 based on a detected speed value and a detected position value obtained by sampling detected pulses transmitted from the first encoder sensor 122 constituting the main-scanning encoder 123 and a target speed value and a target position value obtained from preliminarily-stored speed and position profiles. Further, based on the driving output value, the CPU 501 drives the main scanning motor 25 via the first motor driving unit 510. Similarly, the CPU 501 determines a driving output value (control value) for the sub scanning motor 151 based on a detected speed value and a detected position value obtained by sampling detected pulses transmitted from the second encoder sensor 155 constituting the sub scanning encoder 156 and a target speed value and a target position value obtained from preliminarily-stored speed and position profiles. Further, based on the driving output value, the CPU 501 drives the sub scanning motor 151 via the second motor driving unit 511.

The controller 500 drives the maintenance device 9 via a maintenance-device driving unit 534, moves the caps 92 back and forth with respect to the nozzle faces of the recording heads 24 to seal and unseal the nozzle faces, moves the wiping member 93, and drives a suction pump. By driving a supply pump 13 with a pump driving unit 535, ink is delivered from the main tanks to the head tank 29 or in reverse from the head tank 29 to the main tanks.

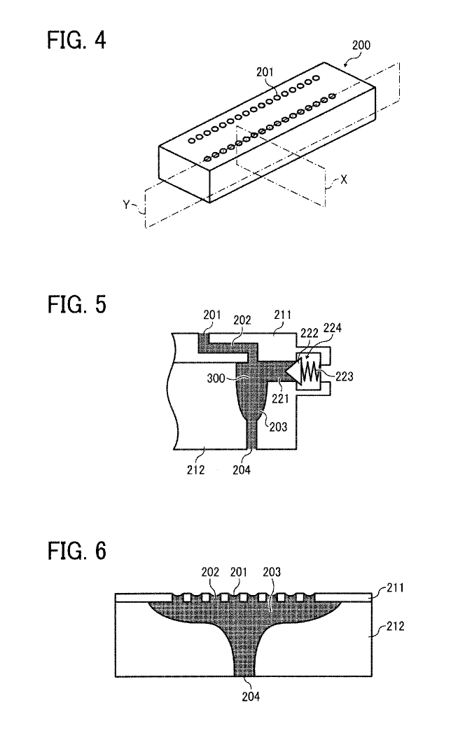

Next, a liquid ejection head serving as the recording head in a first exemplary embodiment of the present disclosure is described with reference to FIGS. 4 to 6.

FIG. 4 is an external perspective view of the liquid ejection head. FIG. 5 is a schematic partial cross-sectional view of the liquid ejection head cut along an X plane of FIG. 4 in a short direction of the head (a direction perpendicular to a nozzle array direction in which nozzles are arrayed in each row). FIG. 6 is a schematic cross-sectional view of the liquid ejection head cut along a Y plane of FIG. 4 in a longitudinal direction (the nozzle array direction).

The liquid ejection head 200 has a channel member 211 and a common-chamber member 212. The channel member 211 includes multiple nozzles 201 and individual liquid chambers 202 communicated with the respective nozzles 201. The common-chamber member 212 includes a common liquid chamber 203 and a liquid supply port 204. Ink is supplied from one of the head tanks 29 to the common liquid chamber 203 via the liquid supply port 204. The common liquid chamber 203 supplies ink to the individual liquid chambers 202.

In this exemplary embodiment, piezoelectric elements are employed as actuators to generate pressure for ejecting liquid droplets in the individual liquid chambers 202. However, it is to be noted that the actuators are not limited to such a piezoelectric type but may be any other suitable type of actuators. The term “chamber” used herein includes “channel”, i.e. a pathway of liquid, and the term “individual liquid chamber” used herein includes, e.g., pressurizing chamber, pressurizing liquid chamber, the pressure chamber, and pressure generation chamber.

As illustrated in FIG. 5, between the individual liquid chamber 202 and the common liquid chamber 203, a bubble discharge channel 221 communicated with the common chamber 203 is disposed to communicate the common chamber 203 with the outside (of the liquid ejection head 200). A valve unit 224 is disposed in the bubble discharge channel 221. The valve unit 224 includes a valve body 222 and a spring 223. The valve body 222 is movable between an open position and a closed position to open and close the bubble discharge channel 221. The spring 223 serves as an urging member to urge the valve body 222 in a direction to close the bubble discharge channel 221.

The urging force of the spring 223 serving as the urging member is set to a force against which the valve body 222 can open when ink is pressurized at a certain pressure and supplied from the liquid supply port 204 to the common liquid chamber 203. In other words, the resistance value of the bubble discharge channel 221 including the valve unit 224 is smaller than the fluid resistance value of a downstream-side channel (the value of resistance against liquid flowing through the channel) downstream from the common liquid chamber 203.

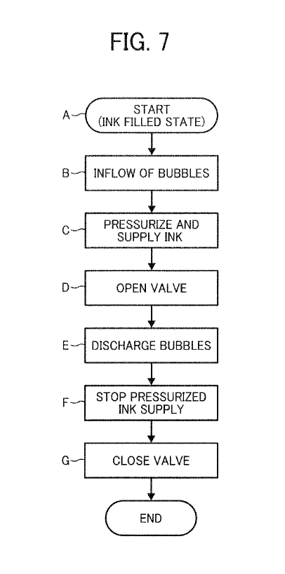

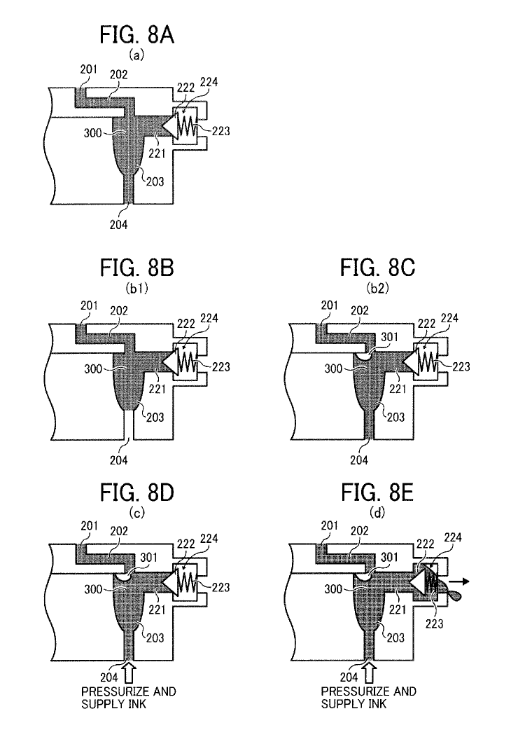

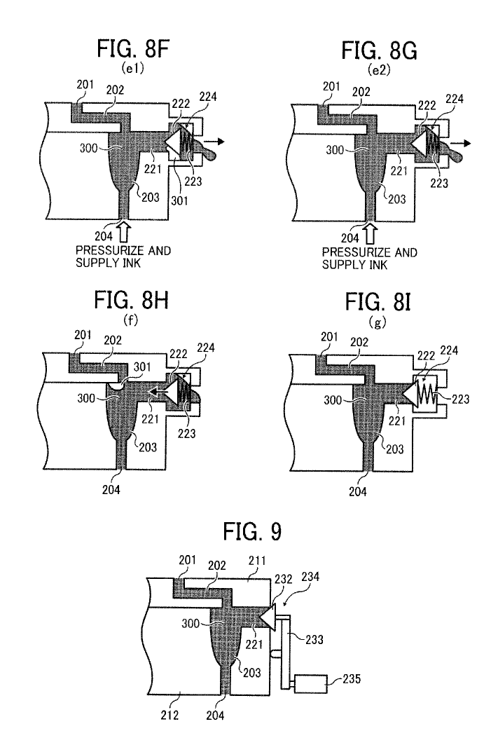

Next, bubble discharging operation according to this exemplary embodiment is described with reference to FIGS. 7 and 8A to 8I.

Steps A to G of FIG. 7 correspond to alphabets (a) to (g) of subscripts in parentheses of FIGS. 8A to 8I.

For the bubble discharging operation, as illustrated in FIG. 7, in a state in which ink is filled in an internal channel of the liquid ejection head 200 (step A), if bubbles flow into the common liquid chamber 203 (step B), ink is pressurized and supplied from the liquid supply port 204 to the common liquid chamber 203 (step C).

By the pressure with which ink is supplied, the valve body 222 of the valve unit 224 moves against the urging force of the spring 223 to the open position to open the valve unit 224 (step D). As a result, since the bubble discharge channel 221 is opened, bubbles are discharged from the bubble discharge channel 221 to the outside of the liquid ejection head 200 (step E). When the pressurized ink supply is stopped (step F), the valve body 222 of the valve unit 224 closes the bubble discharge channel 221 (step G).

For example, in a state in which ink 300 is filled in the internal channel of the liquid ejection head 200 as illustrated in FIG. 8A, as illustrated in FIGS. 8B and 8C, a bubble 301 might flow from the liquid supply port 204 into the common liquid chamber 203.

Here, as illustrated in FIG. 8D (step c), the supply pump 13 is driven to pressurize and supply ink from the liquid supply port 204 to the common liquid chamber 203. At this time, as described above, the urging force of the spring 223 of the valve unit 224 is set to a force against which the valve body 222 can open when ink is pressurized at a certain pressure and supplied from the liquid supply port 204 to the common liquid chamber 203. In other words, the resistance value of the bubble discharge channel 221 including the valve unit 224 is smaller than the fluid resistance value of the downstream-side channel downstream from the common liquid chamber 203. As a result, when ink is supplied from the liquid supply port 204 to the common liquid chamber 203, the valve body 222 opens as illustrated in FIG. 8E.

As a result, since the bubble discharge channel 221 is opened as illustrated in FIGS. 8F and 8G, the bubble 301 is discharged from the bubble discharge channel 221 to the outside of the liquid ejection head 200. Then, when the pressurized ink supply is stopped (FIG. 8H), as illustrated in FIG. 8I, the valve body 222 is closed by the urging force of the spring 223 of the valve unit 224, and the liquid ejection head 200 returns to the normal ink-filled state.

The above-described operation may be performed, e.g., at predetermined constant intervals. Alternatively, a bubble detection sensor may be provided within the liquid ejection head 200 so that, when bubbles flow into the common liquid chamber, the above-described operation can be performed based on detection results of the bubble detection sensor. Furthermore, a droplet detector for detecting droplets ejected from the liquid ejection head 200 with a laser beam may be provided so that, when defective ejection is detected by the droplet detector, the above-described operation can be performed. The control of pressurizing and supplying liquid is performed by the controller 500, which is the same in the following exemplary embodiments.

Next, a second exemplary embodiment of the present disclosure is described with reference to FIG. 9.

FIG. 9 is a schematic partial cross-sectional view of a liquid ejection head according to the second exemplary embodiment.

In this exemplary embodiment, a valve unit 234 has a valve body 232, a lever 233, and a solenoid 235. The valve body 232 opens and closes a bubble discharge channel 221. The solenoid 235 serves as a driving unit to drive the lever 233 to open and close the valve body 232.

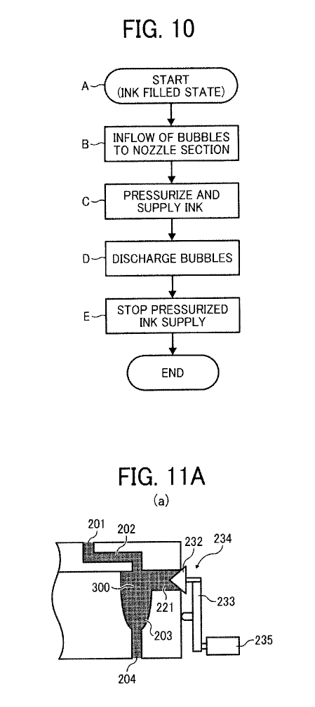

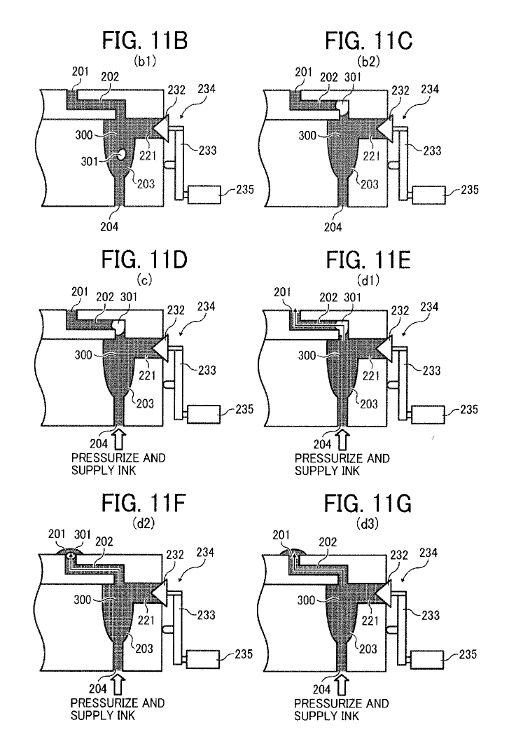

Next, a procedure of bubble discharging operation in the second exemplary embodiment is described with reference to FIG. 10 and FIGS. 11A to 11G.

Steps A to D of FIG. 10 correspond to alphabets (a) to (d) of subscripts in parentheses of FIGS. 11A to 11G.

For the bubble discharging operation, as illustrated in FIG. 10, in a state in which ink is filled in an internal channel of the liquid ejection head 200 (step A), if bubbles flow from a common liquid chamber 203 into an individual liquid chamber 202 (step B), ink is pressurized and supplied from a liquid supply port 204 to the common liquid chamber 203 (step C).

At this time, keeping the closed state of the valve unit 224 prevents ink from flowing into the bubble discharge channel 221 and, as a result, bubbles are discharged through a nozzle 201 from the individual liquid chamber 202 (step D). Then, pressurized ink supply is stopped (step E).

For example, in a state in which ink 300 is filled in the internal channel of the liquid ejection head 200 as illustrated in FIG. 11A (step a), as illustrated in FIGS. 11B and 11C (steps b1 and b2), a bubble 301 might flow from the liquid supply port 204 into the common liquid chamber 203 and move from the common liquid chamber 203 to the individual liquid chamber 202.

Here, as illustrated in FIG. 11D (step c), the supply pump 13 is driven to pressurize and supply ink from the liquid supply port 204 to the common liquid chamber 203. At this time, the bubble discharge channel 221 is in the closed state. As a result, as illustrated in FIGS. 11E to 11G (steps d1 to d3), by the pressurized ink supply, the bubble 301 having flown into the individual liquid chamber 202 is discharged to the outside of the liquid ejection head 200 via the nozzle 201.

Then, since discharged ink may be discharged around an area adjacent to the nozzle 201 of the liquid ejection head 200 as illustrated in FIG. 11G (step d3), the wiping member 93 wipes the nozzle face of the liquid ejection head 200 for cleaning.

Like the first exemplary embodiment, the above-described bubble discharging operation may be performed, e.g., at predetermined constant intervals, on detection of bubbles in the common liquid chamber, or on detection of defective ejection.

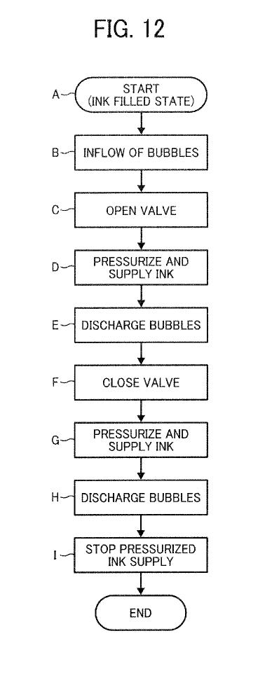

Next, another procedure of bubble discharging operation to discharge bubbles having flown into both a common chamber and an individual liquid chamber in the second exemplary embodiment is described with reference to FIGS. 12, 13A to 13G, and 14A to 14G.

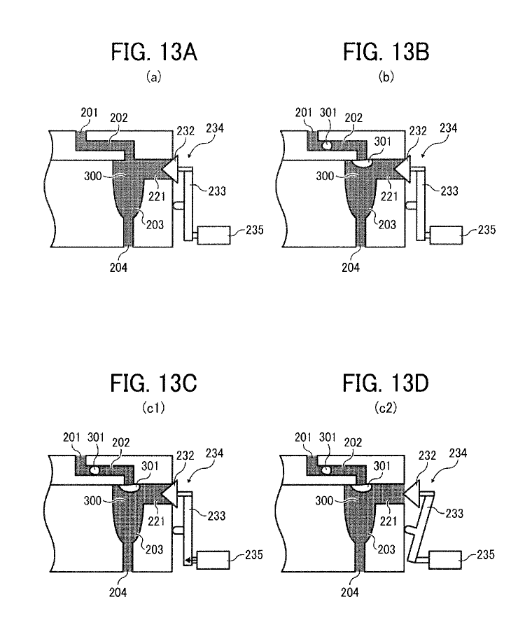

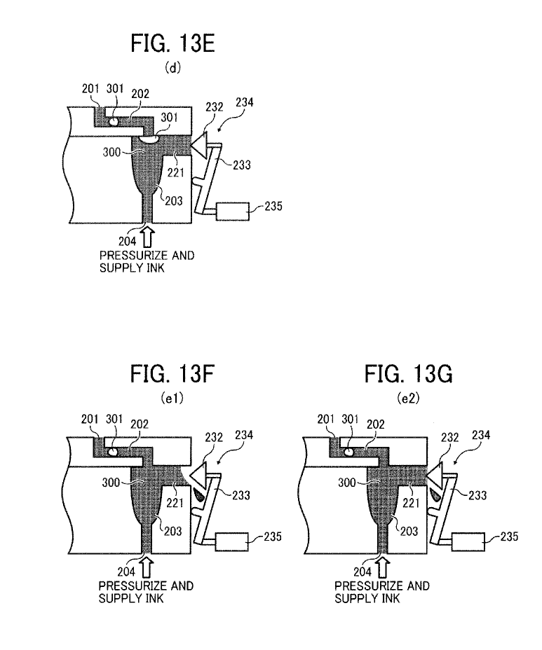

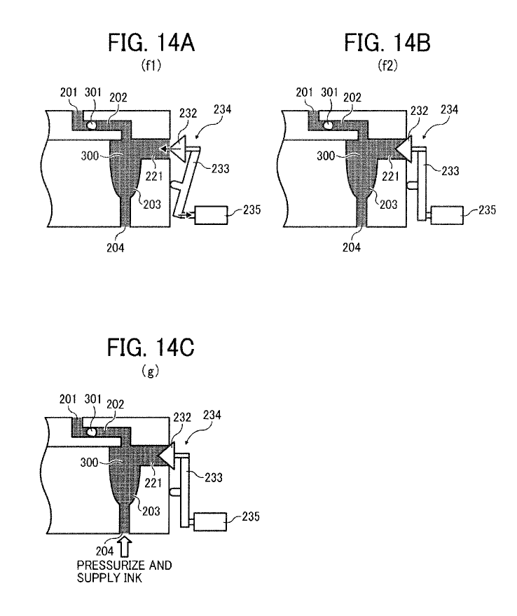

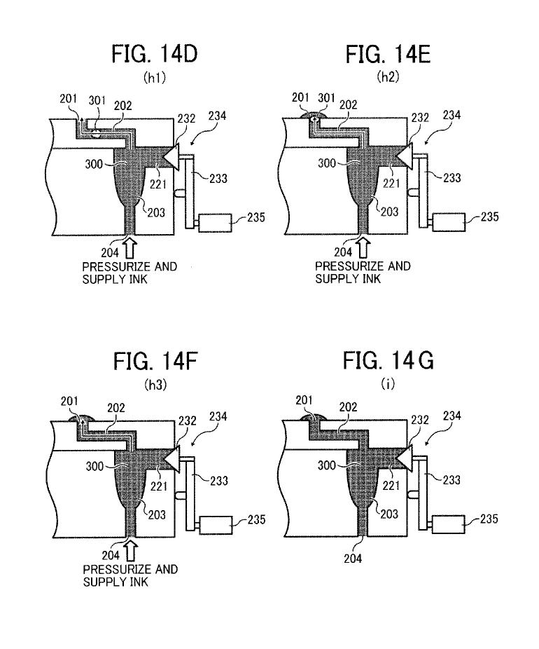

Steps A to I of FIG. 12 correspond to alphabets (a) to (i) of subscripts in parentheses of FIGS. 13A to 13G and FIGS. 14A to 14G.

For the bubble discharging operation, as illustrated in FIG. 12, in a state in which ink is filled in an internal channel of the liquid ejection head 200 (step A), if bubbles flow into the liquid ejection head 200 (step B), the solenoid 235 is driven to open the valve body 232 to open the bubble discharge channel 221 (step C). Then, ink is pressurized and supplied from the liquid supply port 204 to the common liquid chamber 203 (step D).

By the pressure with which ink is supplied, bubbles having flown into the common liquid chamber 203 are discharged from the bubble discharge channel 221 to the outside of the liquid ejection head 200 (step E).

By stopping the solenoid 235, the valve body 232 closes the bubble discharge channel 221 (step F).

Then, ink is pressurized and supplied from the liquid supply port 204 to the common liquid chamber 203 (step G). At this time, as described above, the bubble discharge channel 221 is in the closed state. As a result, by the pressurized ink supply, bubbles having flown into the individual liquid chamber 202 are discharged to the outside of the liquid ejection head 200 via the nozzle 201 (step H). Then, pressurized ink supply is stopped (step I).

For example, in a state in which ink 300 is filled in the internal channel of the liquid ejection head 300 as illustrated in FIG. 13A (step a), as illustrated in FIG. 13B (step b), a first bubble 301 might flow from the liquid supply port 204 into the common liquid chamber 203 and remain in the common liquid chamber 203. Further, a second bubble 301 might move from the common liquid chamber 203 to the individual liquid chamber 202.

Hence, as illustrated in FIGS. 13C and 13D (steps c1 and c2), the solenoid 235 of the valve unit 234 is driven to move the valve body 232 to the open position to open the bubble discharge channel 221. Then, as illustrated in FIG. 13E (step d), ink is pressurized and supplied from the liquid supply port 204 to the common liquid chamber 203.

By the pressure with which ink is supplied, as illustrated in FIGS. 13F and 13G (steps e1 and e2), the first bubble 301 having flown into the common liquid chamber 203 is discharged from the bubble discharge channel 221 to the outside of the liquid ejection head 200.

Then, as illustrated in FIGS. 14A and 14B (steps f1 and f2), when the solenoid 235 of the valve unit 234 is stopped, the valve body 232 moves to the closed position to close the bubble discharge channel 221.

Then, as illustrated in FIG. 14C (step g), ink is pressurized and supplied from the liquid supply port 204 to the common liquid chamber 203.

At this time, as described above, the bubble discharge channel 221 is in the closed state. As a result, as illustrated in FIGS. 14D to 14F (steps h1 to h3), the second bubble 301 having flown into the individual liquid chamber 202 is discharged to the outside of the liquid ejection head 200 via the nozzle 201.

Then, as illustrated in FIG. 14G (step i), the pressurized ink supply is stopped.

Then, since discharged ink may be discharged around an area adjacent to the nozzle 201 of the liquid ejection head 200 as illustrated in FIG. 14G (step i), the wiping member 93 wipes the nozzle face of the liquid ejection head 200 for cleaning.

Like the first exemplary embodiment, the above-described bubble discharging operation may be performed, e.g., at predetermined constant intervals, on detection of bubbles in the common liquid chamber, or on detection of defective ejection.

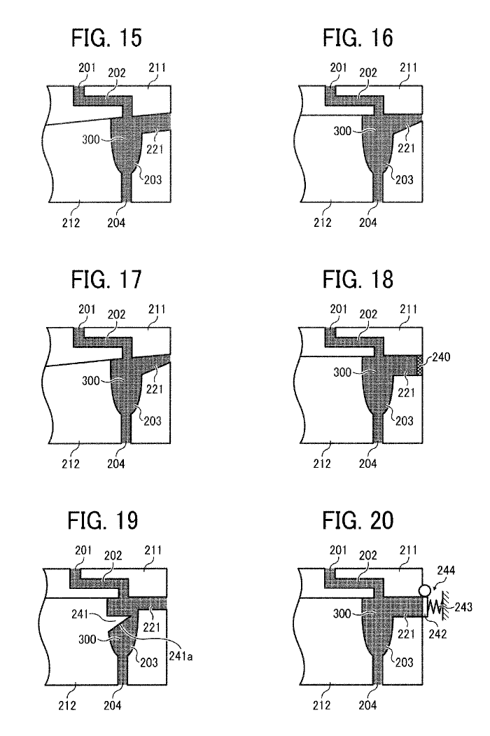

Next, a third exemplary embodiment of the present disclosure is described with reference to FIG. 15.

FIG. 15 is a schematic partial cross-sectional view of a liquid ejection head according to the third exemplary embodiment. In FIG. 15, a valve unit is omitted for simplicity.

In this exemplary embodiment, a bubble discharge channel 221 is inclined so as to become higher in the height direction of the liquid ejection head 200 from an entry proximal to a common liquid chamber 203 to an exit proximal to the outside of the liquid ejection head.

Such a configuration allows bubbles to be more easily discharged from the bubble discharge channel 221 by their flotation.

Next, a fourth exemplary embodiment of the present disclosure is described with reference to FIG. 16.

FIG. 16 is a schematic partial cross-sectional view of a liquid ejection head according to the fourth exemplary embodiment. In FIG. 16, a valve unit is omitted for simplicity.

In this exemplary embodiment, a bubble discharge channel 221 is tapered from an entry proximal to a common liquid chamber 203 to an exit proximal to the outside of the liquid ejection head.

Such a configuration enhances the performance of discharging bubbles.

Next, a fifth exemplary embodiment of the present disclosure is described with reference to FIG. 17.

FIG. 17 is a schematic partial cross-sectional view of a liquid ejection head according to the fifth exemplary embodiment. In FIG. 17, a valve unit is omitted for simplicity.

This exemplary embodiment has a combined configuration of the above-described third and fourth exemplary embodiments, thus enhancing the performance of discharging bubbles.

Next, a sixth exemplary embodiment of the present disclosure is described with reference to FIG. 18.

FIG. 18 is a schematic partial cross-sectional view of a liquid ejection head according to the sixth exemplary embodiment. In FIG. 18, a valve unit is omitted for simplicity.

In this exemplary embodiment, the liquid ejection head has a filter member 240 in the bubble discharge channel 221 to trap foreign substance.

Such a configuration can prevent foreign substance from entering from the outside of the liquid ejection head 200 to the common liquid chamber 203 via the bubble discharge channel 221, thus preventing defective ejection due to nozzle clogging.

Next, a seventh exemplary embodiment of the present disclosure is described with reference to FIG. 19.

FIG. 19 is a schematic partial cross-sectional view of a liquid ejection head according to the seventh exemplary embodiment. In FIG. 19, a valve unit is omitted for simplicity.

In this exemplary embodiment, a wall portion 241 opposing an individual liquid chamber 202 is provided in a common liquid chamber 203. The wall portion 241 has an upstream-side wall face 241a inclined toward the bubble discharge channel 221.

Such a configuration can actively guide bubbles toward the bubble discharge channel 221, thus enhancing the performance of discharging bubbles.

Next, an eighth exemplary embodiment of the present disclosure is described with reference to FIG. 20.

FIG. 20 is a schematic partial cross-sectional view of a liquid ejection head according to the eighth exemplary embodiment. In this exemplary embodiment, the liquid ejection head has a valve unit 244 to open and close a bubble discharge channel 221. The valve unit 244 includes a valve member (valve body) 242 and a spring 243. The valve member 242 is pivotably disposed at the bubble discharge channel 221 to open and close the bubble discharge channel 221. The spring 243 serves as an urging member to urge the valve member 242 in a direction to close the bubble discharge channel 221. Such a configuration can obtain effects equivalent to those of the above-described first exemplary embodiment.

Numerous additional modifications and variations are possible in light of the above teachings. It is therefore to be understood that, within the scope of the appended claims, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

For example, in the above-described exemplary embodiments of this disclosure, the recording heads (liquid ejection heads) eject liquid droplets vertically upward. However, it is to be noted that the droplet ejecting direction of the recording heads are not limited to such a vertically upward direction but the recording heads may eject liquid droplets, for example, obliquely upward. In other words, the nozzle face of each recording head is not necessarily required to be horizontally disposed as illustrated in FIG. 1 and may be tilted relative to the horizontal direction.

What is claimed is:

1. An image forming apparatus comprising a recording head disposed to eject droplets of liquid upward to form an image on a lower face of a recording medium conveyed to a position above the recording head,
the recording head comprising
a plurality of nozzles to eject droplets of the liquid,
a plurality of individual liquid chambers communicated with the plurality of nozzles,
a common liquid chamber communicated with the plurality of individual liquid chambers,
a liquid supply port to supply the liquid to the common liquid chamber,
a bubble discharge channel communicated with the common liquid chamber to communicate the common liquid chamber with an outside of the recording head, and
a valve unit disposed at the bubble discharge channel to open and close the bubble discharge channel.

2. The image forming apparatus of claim 1, wherein the valve unit includes a valve body to open and close the bubble discharge channel and an urging member to urge the valve body with an urging force in a direction to close the bubble discharge channel, and
the urging force of the urging member is set to a force against which the valve body opens when the liquid is pressurized and supplied from the liquid supply port to the common liquid chamber.

3. The image forming apparatus of claim 1, wherein the valve unit includes a valve body to open and close the bubble discharge channel and a driving unit to move the valve body between an open position at which the valve body opens the bubble discharge channel and a close position at which the valve body closes the bubble discharge channel.

4. The image forming apparatus of claim 1, wherein the bubble discharge channel including the valve unit has a fluid resistance value smaller than a channel downstream from the common liquid chamber in the recording head.

5. The image forming apparatus of claim 1, wherein at least one portion of the common liquid chamber is inclined upward toward the bubble discharge channel.

6. The image forming apparatus of claim 1, further comprising a filter member disposed at the bubble discharge channel.

7. The image forming apparatus of claim 1, wherein at least one portion of the bubble discharge channel is inclined upward from an entry of the bubble discharge channel proximal to the common liquid chamber to an exit of the bubble discharge channel proximal to the outside of the recording head.
